(19) United States
(12) Patent Application Publication
(10) Pub. No.: US 2012/0299781 A1
(43) Pub. Date: Nov. 29, 2012

(54) ANTENNA FOR A PORTABLE COMPUTER

(75) Inventor: SUNGGYOO LEE, MACHIDA-SHI (JP)

(73) Assignee: LENOVO (SINGAPORE) PTE. LTD., SINGAPORE (SG)

(21) Appl. No.: 13/468,452

(22) Filed: May 10, 2012

(30) Foreign Application Priority Data
May 24, 2011 (JP) 2011-116272

(51) Int. Cl. H01Q 1/36

(52) U.S. Cl. 343/700 MS

(57) ABSTRACT

An antenna for a portable computer is disclosed. The antenna includes a ground element, a first and second radiating elements, and a driven element. The ground element is linearly extended on a surface of a circuit substrate. The first radiating element, which is adapted to a first frequency band, includes a horizontal-portion pattern extending substantially parallel to the ground element on the surface of the circuit substrate. The driven element, which is provided on the surface of the circuit substrate between the ground element and the horizontal-portion pattern, supplies electromagnetic-wave energy to the first radiating element. The second radiating element is provided on the surface of the circuit substrate between the ground element and the horizontal-portion pattern. The second radiating has contact with the driven element, and is adapted to a second frequency band and a third frequency band that is higher than the second frequency band.

### PRIORITY CLAIM

The present application claims benefit of priority under 35 U.S.C. §§120, 365 to the previously filed Japanese Patent Application No. JP2011-116272 entitled, “ANTENNA FOR WIRELESS TERMINAL DEVICE” with a priority date of May 24, 2011, which is incorporated by reference herein.

### BACKGROUND

1. Technical Field

The present invention relates to antennae in general, and in particular to a small antenna for a portable computer.

2. Description of Related Art

A laptop portable computer (PC) is equipped with many antennae for wireless communications such as Bluetooth, wireless LAN and wireless WAN. The laptop PC communicates data using a wireless WAN that utilizes a communication network for mobile phones. In North America, mobile phones use frequencies in a Personal Communications Service (PCS) band of 3^{rd} generation (3G) and a cellular band. The cellular band has used a frequency band from 820 MHz to 960 MHz as the 800 MHz zone. Further, a mobile communication service based on a communication protocol called Long Term Evolution (LTE) of 4^{th} generation (4G) also uses the cellular band. In the United States, Verizon Wireless has already provided wireless data communication service based on LTE, and AT&T plans a similar service. Verizon Wireless uses a frequency band from 747 MHz to 787 MHz, and AT&T is going to use a frequency band from 704 MHz to 746 MHz. Further, the service of LTE with a frequency band from 790 MHz to 862 MHz is planned in Europe. A user typically uses one single laptop PC when traveling all over the world; thus, the laptop PC must be equipped with antennas adapted to many different frequency bands.

A laptop PC is also equipped with an antenna for receiving Global Positioning System (GPS) radio signals, so as to use location information in applications or to control a wireless module's communication method. Thus, a laptop PC must have many antennae close to each other in a small space, and they are placed so that no mutual radio-wave interference occurs. Thus, it is necessary for both an antenna element adapted to a frequency band with a wide bandwidth of the wireless WAN and an antenna element adapted to GPS to share the same substrate.

As resonance frequency is lowered, an antenna element must be made longer or larger. Particularly, the antenna tends to be larger when it is adapted to a relatively low frequency such as 700 MHz and to as wide a band as possible. Further, when several elements adapted to different frequency bands are provided in one circuit substrate, it is necessary to leave a space between the antenna elements to avoid radio-wave interference, which tends to make the antenna larger.

Further, when an antenna is configured to obtain a fundamental frequency and a resonance frequency of the third harmonic, frequencies to be obtained are limited to the fundamental frequency and a frequency that is three times the fundamental frequency. Accordingly, the antenna cannot be adapted to other frequency bands.

In order to form antenna elements adapted to multiple frequency bands in one substrate, it is necessary to devise placement that restrains radio-wave interference and shrinks the antenna. Moreover, in order to form an antenna adapted to the wireless WAN, it is necessary to broaden the frequency band of a low-frequency side so that the antenna can be adapted to frequency bands that various countries and companies provide.

### SUMMARY

In accordance with a preferred embodiment of the present invention, an antenna includes a ground element, a first and second radiating elements, and a driven element. The ground element is linearly extended on a surface of a circuit substrate. The first radiating element, which is adapted to a first frequency band, includes a horizontal-portion pattern extending substantially parallel to the ground element on the surface of the circuit substrate. The driven element, which is provided on the surface of the circuit substrate between the ground element and the horizontal-portion pattern, supplies electromagnetic-wave energy to the first radiating element. The second radiating element is provided on the surface of the circuit substrate between the ground element and the horizontal-portion pattern. The second radiating has contact with the driven element, and is adapted to a second frequency band and a third frequency band that is higher than the second frequency band.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a perspective view of an antenna for a laptop PC, in accordance with a preferred embodiment of the present invention;

FIG. 2 illustrates a frequency-shift circuit for shifting a resonance frequency of a wireless WAN of a low-frequency side;

FIG. 3 shows the voltage standing-wave ratio characteristics of the antenna from FIG. 1; and

FIG. 4 is a plane view of an antenna attached to a laptop PC.

### DETAILED DESCRIPTION OF A PREFERRED EMBODIMENT

### I. The Antenna Structure

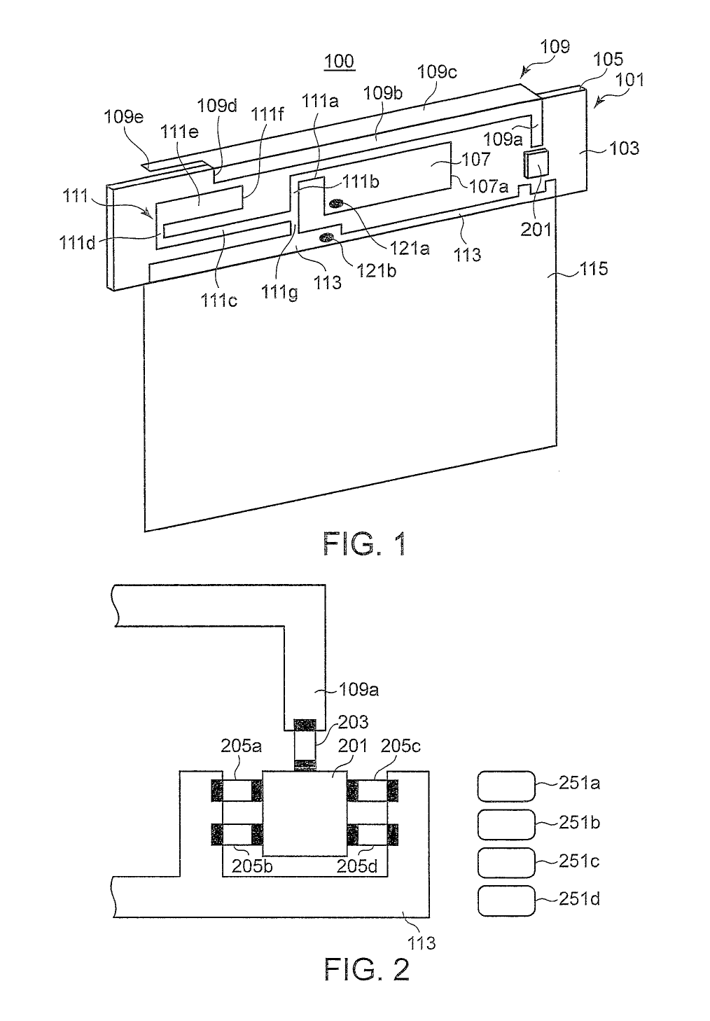

FIG. 1 is a perspective view of an antenna for a laptop PC, in accordance with a preferred embodiment of the present invention. As shown, an antenna 100 is formed by performing photolithography and etching processes on a printed circuit board. The antenna 100 has three components: an antenna pattern formed on a main surface 103 of a dielectric substrate 101, and a horizontal-extension pattern 109c and a ground plane 115 each of which is connected to the antenna pattern on the main surface 103 by soldering. The plane containing the horizontal-extension pattern 109c intersects with the main surface 103 of the dielectric substrate 101 at 90 degrees.

The dielectric substrate 101 is a laminated-shape rectangular solid having the main surface 103 providing an area for forming the antenna pattern, and four side surfaces 105. On the main surface 103, patterns of a driven element 107, a radiating element 109, a radiating element 111, and a ground element 113 are formed. The ground element 113 is a linear pattern extending parallel to one linear edge of the ground plane 115 so as to provide an area for connecting the ground plane 115 thereto. In the ground element 113, a power feeding section 121b on a ground side is defined at a substantially central portion in a longitudinal direction of the ground element 113.

The antenna pattern includes: a passive radiating element 109 that is adapted to four channels of a low-frequency-side wireless WAN in a range from 704 MHz to 960 MHz; a power-feeding radiating element 111 that is adapted to two frequency bands for GPS of 1574 MHz to 1576 MHz and a high-frequency-side wireless WAN of 1700 MHz to 2200 MHz; and a driven element 107 supplying electromagnetic-wave energy to the radiating element 109 by electrostatic coupling and electromagnetic coupling.

As will be described later, the radiating element 109 can be adapted to frequency bands of four channels by changing a reactive element to be connected between the radiating element 109 and the ground element 113. As an example, the first channel is from 704 MHz to 746 MHz, the second channel is from 747 MHz to 787 MHz, the third channel is from 790 MHz to 862 MHz, and the fourth channel is from 860 MHz to 960 MHz.

The driven element 107 is a linear monopole antenna which resonates at a quarter wavelength, and extends parallel to the ground element 113. An open end 107a of the driven element 107 has a short length so that a predetermined space is formed from a vertical portion 109a of the radiating element 109, thereby restraining radio-wave interference. The length of the driven element 107 is set so that the driven element 107 resonates at a quarter wavelength of the third harmonic of a fundamental frequency (832 MHz), which is a center of the overall bandwidth of the radiating element 109. Note that, in the present specification, the vertical and horizontal directions are directions with respect to the ground element 113.

A power feeding section 121a on a voltage side is defined in the driven element 107 at a position opposite to the open end 107a. A coaxial cable connected to a wireless module including a high-frequency oscillator is connected to the power feeding sections 121a and 121b as only power feeding points for the antenna 100. The wireless module is provided in a laptop PC and serves as an interface for converting an internal digital signal and a wireless high-frequency signal.

In vicinity to one end portion of the ground element 113, that vertical-portion pattern 109a of the radiating element 109 which extends vertically is provided. The vertical-portion pattern 109a and the ground element 113 do not have direct contact with each other; a switching IC 201 is attached between them. As illustrated in FIG. 2, multiple capacitors of different electrostatic capacitances are provided around the switching IC. The switching IC 201 receives a control signal from the wireless module, and controls which one of the different capacitors is used to connect the vertical-portion pattern 109a and the ground element.

A horizontal-portion pattern 109b has contact with the vertical-portion pattern 109a. The horizontal-portion pattern 109b extends to the open end 109d in parallel with the ground element 113. The horizontal-portion pattern 109b includes the horizontal-extension pattern 109c provided on a plane intersecting with the main surface 103 at 90 degrees. Note that 90 degrees as the intersection angle is preferable in the laptop PC environment, but the intersection angle may be larger.

The horizontal-extension pattern 109c is formed of a flat laminated-shape conductor, and provided along a side surface 105 of the dielectric substrate 101. The horizontal-extension pattern 109c is connected to the horizontal-portion pattern 109b by soldering. The horizontal-extension pattern 109c extends in parallel with the ground element 113 up to an open end 109e, which is farther away from the open end 109d of the horizontal-portion pattern 109b. In the present embodiment, the horizontal-extension pattern 109c and the horizontal-portion pattern 109b, which are produced as separate members, are connected by soldering, but they may be formed as an integrated pattern and folded afterwards. The radiating element 109 is configured such that its resonance frequency is determined in accordance with length of a pattern from the ground element 113 to the open end 109e and electrical length corresponding to a capacitance of a capacitor that is connected at that time, and the radiating element 109 radiates or receives electromagnetic wave as an inverted-L quarter-wave monopole antenna.

The horizontal-portion pattern 109b is provided so that it is parallel to the driven element 107 on the main surface 103, and performs electrostatic coupling and electromagnetic coupling therewith to receive electromagnetic-wave energy from the driven element 107. The radiating element 109 resonates at a frequency of the third harmonic at which the driven element 107 resonates. The length of the radiating element 109 from an open end of the vertical-portion pattern 109a on the side of the ground element 113 to the open end 109e of the horizontal-extension pattern 109c is set so that the radiating element 109 resonates at a quarter wavelength of a wavelength of a frequency which is slightly higher than the fundamental frequency of the fourth channel which the radiating element 109 radiates. Further, by increasing the capacitance of a capacitor to be connected, the resonance frequency is shifted to a direction of a lower frequency.

When two patterns each parallel to the ground element 113 extend so as to overlap each other when viewed from a direction vertical to the ground element 113, this is called an overlap. The horizontal-portion pattern 109b and the driven element 107 are provided on the main surface 103 so as to overlap each other, creating an electrical connection to allow transmission and reception of the electromagnetic-wave energy between them.

In vicinity to a central portion of the ground element 113, a short-circuit-portion pattern 111g of the radiating element 111 has contact therewith. Via the short-circuit-portion pattern 111g, a vertical-portion pattern 111b has vertical contact with the ground element 113 on a side of the power feeding section 121a. The vertical-portion pattern 111b and the driven element 107 have contact with each other via a horizontal-portion pattern 111a. From the short-circuit pattern 111g, a horizontal-portion pattern 111c extends parallel to the ground element 113 in a direction opposite to the driven element 107. The horizontal-portion pattern 111c has contact with a horizontal-portion pattern 111e via a folding portion 111d.

An open end 111f of the horizontal-portion pattern 111e is provided so as not to face the open end 109e of the horizontal-extension pattern 109c on the main surface 103. In the length from the short-circuit-portion pattern 111g to the open end 111f, the radiating element 111 resonates with the fundamental frequency of GPS at its quarter wavelength to work as an inverted-F quarter-wave monopole antenna, so as to receive electromagnetic wave. Moreover, in the radiating element 111, currents flowing in the horizontal-portion pattern 111c and in the horizontal-portion pattern 111e are reversed to each other at the folding portion 111d. For this, in the length from the short-circuit-portion pattern 111g to the folding portion 111d, the radiating element 111 resonates with the fundamental frequency of PCS at its quarter wavelength to work as an inverted-F quarter-wave monopole antenna, so as to radiate or receive electromagnetic wave.

### II. The Frequency-Shift Circuit

With reference now to FIG. 2, there is illustrated a frequency-shift circuit. The frequency-shift circuit is mainly constituted by a switching IC 201 and five capacitors. The capacitor 203 is configured such that one end is connected to the vertical-portion pattern 109a and another end is connected to the switching IC 201. Capacitors 205a to 205d are each configured such that one end is connected to the switching IC 201 and another end is connected to the ground element 113. Switching IC 201 constitutes a multiplexer for connecting the capacitor 203 to any capacitor selected from the four capacitors 205a to 205d.

Respective capacitances of the capacitors are assumed such that the capacitor 203 is 200 pF, the capacitor 205a is 1.5 pF, the capacitor 205b is 2.4 pF, the capacitor 205c is 4.7 pF, and the capacitor 205d is 6.8 pF. The capacitor 203 is inserted for the purpose of blocking a direct-current component flowing into the radiating element 109. The four capacitors 205a-205d adjust capacitive reactance of the radiating element 109 so as to shift the resonance frequency.

Terminals 251a and 251b are connected to a control circuit of the wireless module. Terminals 251c and 251d are connected to a direct-current power supply for operating the switching IC 201. Terminals 251a to 251d are connected to the switching IC 201 and the ground element 113 through a pattern (not shown) on the main surface 103 of the dielectric substrate 101 and a pattern of a rear surface thereof connected through a via. Note that a resistor and a capacitor are further connected to this frequency-shift circuit, but they are not necessary for explanation of the operation and therefore they are omitted in the drawings.

Based on a control signal received by the terminals 251a and 251b from the wireless module, the switching IC 201 connects any capacitor selected from the capacitors 205a to 205d with the capacitor 203. As a result, the vertical-portion pattern 109a and the ground element 113 are connected with each other by a series circuit of the capacitor 203 and any of the capacitors 205a to 205d.

The capacitors 205a to 205d shift the resonance frequency of the radiating element 109 to a lower frequency as the capacitance is larger. The capacitor 205a corresponds to the fourth channel, the capacitor 205b corresponds to the third channel, the capacitor 205c corresponds to the second channel, and the capacitor 205d corresponds to the first channel. The switching IC 201 can be provided at a position away from a part with a strong electric field, such as the horizontal-portion pattern 109b of the radiating element 109 and the open end 107a of the driven element 107, so that the switching IC 201 does not attenuate the gain of the antenna 100.

### III. Antenna Behavior

The following describes the behavior of the antenna 100. A coaxial cable is connected to the power feeding points 121a and 121b so as to feed them with a high-frequency voltage from the wireless module. When a wireless WAN of the low-frequency side is used, the wireless module transmits to the terminals 251a and 251b a control signal for selecting the first channel, for example. The switching IC 201 connects the vertical-portion pattern 109a to the ground element 113 via the capacitor 205a.

The wireless module feeds the power feeding sections with a high-frequency voltage of the frequency of the first channel In the driven element 107, the third harmonic of the frequency of the first channel resonates at a quarter wavelength, so that electromagnetic-wave energy is supplied to the horizontal-portion pattern 109b by electromagnetic coupling and electrostatic coupling. In the electric length from the capacitor 205a to the open end 109e, the radiating element 109 resonates at a quarter wavelength of the fundamental frequency of the first channel due to the electromagnetic-wave energy thus received. The other channels are the same as above. At this time, since the open end 109e of the radiating element 109 is provided on a plane different from one where the radiating element 111 is provided, radio-wave interference between the radiating element 109 and the radiating element 111 for receiving radio wave of GPS is restrained.

Next will be explained a case where a wireless WAN of the high-frequency side or GPS is used. The wireless WAN of the high-frequency side and GPS both use the radiating element 111 working as an inverted-F antenna. When the antenna 100 receives radio wave of GPS, the whole pattern from the short-circuit-portion pattern 111g to the open end 11 if resonates at a quarter wavelength of the fundamental frequency of GPS, and transmits a high-frequency voltage to the wireless module. When the wireless module supplies the power feeding points 121a and 121b with the high-frequency voltage at the frequency of the wireless WAN of the high-frequency side, the horizontal-portion pattern 111c from the short-circuit-portion pattern 111g to the folding portion 111d resonates at a quarter wavelength of the fundamental frequency, and radiates electromagnetic wave.

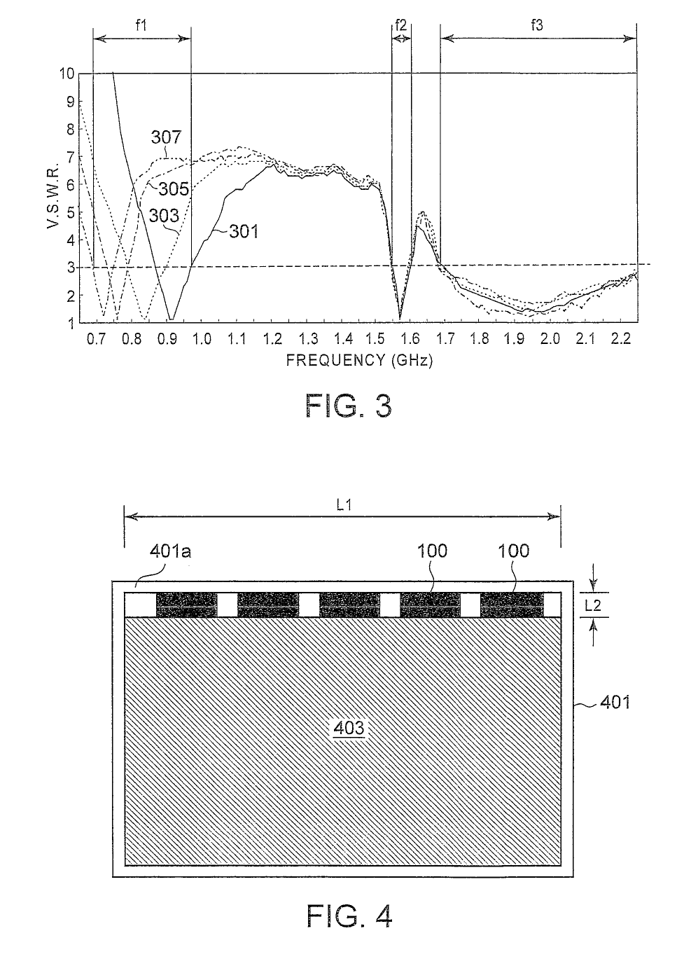

FIG. 3 shows the results of simulation of a voltage standing-wave ratio (VSWR) of the antenna 100. Lines 301, 303, 305, and 307 respectively show characteristics when the capacitors 205a, 205b, 205c, and 205d are connected. According to FIG. 3, in a frequency band f1 for the low-frequency wireless WAN from 704 MHz to 960 MHz, the VSWR of each of the first channel to the fourth channel is not more than 3, which indicates that a wide frequency band is realized. Further, even in a frequency band f2 for GPS from 1574 MHz to 1576 MHz and a frequency band f3 for the high-frequency-side wireless WAN from 1700 MHz to 2200 MHz, the VSWR is not more than 3, and thus good characteristics are exhibited.

FIG. 3 further shows that the characteristics of GPS and the wireless WAN of the high-frequency side do not change when any of the capacitors 205a to 205d is selected to set a channel for the wireless WAN of the low-frequency side. In the antenna 100, a capacitor for reactance adjustment is inserted into the radiating element 109, which is a passive radiating element. Therefore, even if the capacitors 205a to 205d are changed, there is no influence on resonance frequencies in other frequency bands, and the antenna 100 operates stably at any of three frequency bands.

FIG. 4 is a plane view illustrating a state where the antenna 100 is attached to a laptop PC. A display housing 401 houses a liquid crystal display (LCD) 403 therein. Between an upper edge 401a of the display housing 401 and the LCD 403, five antennas in total are provided in a space secured with a longitudinal length L1 and a short-side length L2. The antennas can have different structures, but in this particular example, antennas 100 are mounted as two adjacent antennas. Each antenna 100 is provided so that an antenna pattern on a main surface 103 is parallel to a bottom surface of the display housing 401, and a ground plane 115 is provided between the LCD 403 and the bottom surface of the display housing 401.

The antenna 100 is formed so that the short-side length of the main surface 103 is less than L2. Further, when five antennas are placed within the length L1 of the display housing 401, it is difficult to secure sufficient spaces between them. In this case, when the open ends of a driven element and a radiating element (at which the electric field intensity is largest) are close to adjacent antenna, radio-wave interference may be caused in some cases. However, when two antennas 100 are provided side by side as a main antenna and a support antenna, they do not cause radio-wave interference to each other because the open end 109e is provided on a plane different from the main surface 103.

Further, the open end 111f of the radiating element 111 does not cause radio-wave interference to its adjacent antenna because the open end 111f faces a direction of the driven element 107. The size of the antenna 100 is substantially determined by the size of the radiating element 109 which is adapted to the wireless WAN of the low-frequency side, and the driven element 107 and the radiating element 111 which is adapted to GPS and the wireless WAN of the high-frequency side can be placed within the space on the main surface 103 surrounded by the radiating element 109 and the ground element 113, thereby making it possible to realize downsizing Accordingly, the antenna 100 has a structure suitable for such a placement when antennas adapted to multiple frequency bands are placed in a limited space.

As has been described, the present invention provides an antenna for a laptop PC.

While the invention has been particularly shown and described with reference to a preferred embodiment, it will be understood by those skilled in the art that various changes in form and detail may be made therein without departing from the spirit and scope of the invention.

What is claimed is:

1. An antenna comprising:
a ground element linearly extending on a surface of a circuit substrate;
a first radiating element, which is adapted to a first frequency band, includes a horizontal-portion pattern extending substantially parallel to said ground element on said surface of said circuit substrate;
a driven element provided on said surface of said circuit substrate between said ground element and said horizontal-portion pattern to supply electromagnetic-wave energy to said first radiating element; and
a second radiating element, which is adapted to a second frequency band and a third frequency band that is higher than said second frequency band, located on said surface of said circuit substrate between said ground element and said horizontal-portion pattern to provide contact with said driven element.

2. The antenna of claim 1, wherein said first radiating element is an inverted-L monopole antenna, and said second radiating element is an inverted-F monopole antenna.

3. The antenna of claim 1, wherein said driven element is a linear monopole antenna.

4. The antenna of claim 1, wherein said driven element resonates at a harmonic of wavelength of electromagnetic wave radiated by said first radiating element.

5. The antenna of claim 1, wherein said second radiating element includes a first horizontal-portion pattern having contact with said driven element and a second horizontal-portion pattern having an open end and folded at a folding portion toward a direction of said driven element.

6. The antenna of claim 1, wherein said horizontal-portion pattern of said first radiating element is provided on a plane intersecting with said surface of said circuit substrate at a right angle and has an open end.

7. The antenna of claim 1, further comprising:
a plurality of capacitors having different capacitances; and
a switching circuit connecting said first radiating element to said ground element by a capacitor selected from said plurality of capacitors in response to an instruction from a wireless module.

8. The antenna of claim 1, wherein said first frequency band and said third frequency band are adapted to wireless WANs, and said second frequency band is adapted to GPS.

9. The antenna of claim 8, wherein said first frequency band is from 704 MHz to 960 MHz, and said third frequency band is from 1700 MHz to 2200 MHz.

10. An antenna comprising:
a ground element provided on a surface of a circuit substrate;
a passive inverted-L radiating element, which is adapted to a first frequency band, includes a pattern located on said surface of a circuit substrate and a pattern located on a plane different from said surface of a circuit substrate;
a driven element located on said circuit substrate so as to be surrounded by said inverted-L radiating element and said ground element and supplying energy to said inverted-L radiating element by electromagnetic coupling and electrostatic coupling; and
an inverted-F radiating element, which is adapted to a second frequency band and a third frequency band that is higher than said second frequency band, located on said circuit substrate so as to be surrounded by said inverted-L radiating element and said ground element, including a pattern having a folding portion.

11. The antenna of claim 10, wherein an open end of said inverted-F radiating element faces said driven element.

12. The antenna of claim 10, wherein said inverted-L radiating element is connected to said ground element via a switchable reactive element.

13. An antenna comprising:
a ground element provided on a surface of a circuit substrate;
a passive radiating element, which is adapted to a first frequency band, is located on said surface of a circuit substrate, wherein said passive radiating element is connected to said ground element via a reactive element;
a feed element located on said surface of the circuit substrate to supply electromagnetic-wave energy to said passive radiating element; and
a power-feeding radiating element, which is adapted to a second frequency band and a third frequency band that is higher than said second frequency band, located on said surface of the circuit substrate to provide contact with said feed element, wherein said power-feeding radiating element includes a folding portion.

14. The antenna of claim 13 further comprising:
a plurality of reactive elements having different capacitances; and
a switching circuit for connecting any of said plurality of reactive elements between said passive radiating element and said ground element.

15. The antenna of claim 14, wherein the reactive elements are capacitors.
